(19) United States
(12) Patent Application Publication
(10) Pub. No.: US 2026/0369449 A1
(43) Pub. Date: Nov. 19, 2026

(54) RARE EARTH MAGNETIC POWDER PARTICLE, MAGNETIC PARTICLE, AND MANUFACTURING METHOD OF RARE EARTH MAGNET

(71) Applicant: HONDA MOTOR CO., LTD., Tokyo (JP)

(72) Inventors: Akihito NINOMIYA, Saitama (JP); Ibuki OTA, Saitama (JP); Yasutaka SHINTANI, Saitama (JP)

(21) Appl. No.: 19/575,515

(22) Filed: Mar. 23, 2026

(30) Foreign Application Priority Data
Mar. 31, 2025 (JP) 2025-060071

(51) Int. Cl. H01F 1/06; B22F 1/05; B22F 1/068; B22F 1/145; B22F 1/16; B22F 3/14; B22F 3/17

(52) U.S. Cl. CPC H01F 1/06; B22F 1/05; B22F 1/068; B22F 1/145; B22F 1/16; B22F 3/14; B22F 3/17; B22F 2302/45; B22F 2304/15; B22F 2998/10; B22F 2999/00

(57) ABSTRACT

A rare earth magnetic powder particle has a flake shape and a particle diameter of 500 μm to 600 μm. A magnetic particle includes a flake-shaped rare earth magnetic powder particle having a particle diameter of 500 μm to 600 μm, and an insulating layer formed on a surface of the rare earth magnetic powder particle. A manufacturing method of a rare earth magnet includes: an insulating layer forming step of forming an insulating layer on a surface layer of flake-shaped rare earth magnetic powder particles to obtain magnetic particles, each of the flake-shaped rare earth magnetic powder particles having a particle diameter of 500 μm to 600 μm; a primary molding step of primary molding the magnetic particles to obtain a primary molded product; and a hot plastic working step of performing hot plastic working on the primary molded product to obtain the rare earth magnet.

### TECHNICAL FIELD

The present invention relates to a rare earth magnetic powder particle used as a material for a rare earth magnet, a magnetic particle used as a material for the rare earth magnet, and a manufacturing method of the rare earth magnet.

### BACKGROUND ART

In recent years, efforts have been actively made to realize a low-carbon or decarbonized society, and research and development of electrification technology is being conducted for vehicles to reduce CO₂ emissions and improve energy efficiency. Methods for improving energy efficiency include improving the efficiency of motors used as power sources. In recent years, rare earth magnets have been widely used to improve motor efficiency. There is a need to improve magnetic properties of rare earth magnets. Since rare earth magnets are metallic magnets having low electrical resistivity, eddy current loss is likely to increase. Therefore, technologies for reducing eddy current loss in rare earth magnets have been proposed.

JP4784173B discloses a rare earth magnet capable of reducing eddy current losses, having rare earth magnetic powder particles, each covered with a film-like coating layer containing rare earth oxides. Bond portions containing rare earth oxide particles are interposed between the magnet powder particles coated with the rare earth oxides. A method of producing the rare earth magnet comprises conducting high-temperature pressure forming of a mixture of rare earth oxides and rare earth magnetic powder particles coated with the rare earth oxides.

JP2003-22905A discloses a manufacturing method of a rare earth magnet, comprising: mixing a magnet powder particles composed mainly of an alloy containing a Nd₂Fe₁₄B compound with one or more insulating compounds selected from oxide such as CaO, nitride such as BN, or fluoride such as CaF₂ for the purpose of increasing the electrical resistivity of the rare earth magnet; and processing the resulting mixture by hot plastic working to obtain an anisotropic magnetic material.

JP2010-27852A discloses that a first manufacturing method of a rare earth magnet comprises: preparing isotropic rapid-cooled powder particles such as Nd—Fe—B magnet powder particles; mixing the isotropic rapid-cooled powder particles with a predetermined compound for forming insulating layers; processing the mixture by cold molding to produce a cold molded product (temporary molding); processing the cold molded product by hot molding (densifying); and processing, by hot plastic molding, the resultant product (imparting anisotropy) to produce the rare earth magnet, and that a so-produced magnet includes generally stacked Nd—Fe—B rapid-cooled powder particles with the compound powder material interposed between, each particle having a long side length of 100 to 400 μm and a thickness of 20 to 40 μm.

In the rare earth magnet described in JP4784173B, an insulating material composed of dysprosium oxide (Dy₂O₃) is used as the rare earth oxide. Since dysprosium oxide has hygroscopicity, moisture adsorbed onto the dysprosium oxide may reduce the magnetic properties of the rare earth magnet. In the manufacturing method of the rare earth magnet described in JP2003-22905A, in the mixing process of mixing the Nd—Fe—B magnet powder particles with the insulating compound, the magnet powder particle is pulverized and excessively subdivided, which increases a specific surface area of the magnet powder particle and makes the magnet powder particle more susceptible to oxidation. Accordingly, oxidation of the rare earth magnet may cause a reduction in magnetic flux density of the rare earth magnet.

In the manufacturing method of the rare earth magnet described in JP2010-27852A, compound A, which is at least one compound selected from the group consisting of fluorides, oxides, and inorganic salts of heavy rare earth elements, is reacted with compound B, which is a hydride of an alkaline earth metal, during the hot forming and heat treatment step. Here, side reactions such as oxidation of the magnet, or the reaction between compound A and compound B not proceeding appropriately may result in a reduction in the magnetic properties of the manufactured rare earth magnet. Accordingly, there is a demand for a material for a rare earth magnet having improved magnetic properties and a rare earth magnet having improved magnetic properties.

### SUMMARY OF THE INVENTION

In view of the above background, an object of the present invention is to provide a rare earth magnetic powder particle and a magnetic particle used as materials for a rare earth magnet having improved magnetic properties such as a residual magnetic flux density, and to provide a manufacturing method of a rare earth magnet having improved magnetic properties such as a residual magnetic flux density, which consequently contributes to improving energy efficiency.

To achieve such an object, one aspect of the present invention provides a rare earth magnetic powder particle used as a material for a rare earth magnet, the rare earth magnetic powder particle having a flake shape and a particle diameter of 500 μm or more and 600 μm or less, wherein the particle diameter is defined as a maximum Feret diameter measured in a direction parallel to a main surface of the flake-shaped rare earth magnetic powder particle. In the present specification, the term “particle diameter” refers to a maximum Feret diameter measured in a direction parallel to a main surface of the flake-shaped rare earth magnetic powder particle, unless otherwise specified.

According to this aspect, it is possible to provide the rare earth magnetic powder particle used as the material for the rare earth magnet which can contribute to improved magnetic properties.

To achieve such an object, another aspect of the present invention provides a magnetic particle used as a material for a rare earth magnet, comprising: a flake-shaped rare earth magnetic powder particle; and an insulating layer having insulating properties and formed on a surface of the rare earth magnetic powder particle. The rare earth magnetic powder particle has a particle diameter of 500 μm or more and 600 μm or less.

According to this aspect, it is possible to provide the magnetic particle used as the material for the rare earth magnet which can contribute to improved magnetic properties.

To achieve such an object, another aspect of the present invention provides a manufacturing method of a rare earth magnet, comprising: an insulating layer forming step of forming an insulating layer having insulating properties on a surface layer of a plurality of flake-shaped rare earth magnetic powder particles to obtain a plurality of magnetic particles, each of the flake-shaped rare earth magnetic powder particles having a particle diameter of 500 μm or more and 600 μm or less; a primary molding step of primary molding, using a hot press, the plurality of magnetic particles obtained in the insulating layer forming step to obtain a primary molded product in which the plurality of magnetic particles is primarily molded; and a hot plastic working step of performing hot plastic working on the primary molded product obtained in the primary molding step to obtain the rare earth magnet.

According to this aspect, it is possible to manufacture the rare earth magnet having improved magnetic properties.

Thus, according to the above aspects, it is possible to provide a rare earth magnetic powder particle and a magnetic particle used as materials for a rare earth magnet having improved magnetic properties, and to provide a manufacturing method of a rare earth magnet having improved magnetic properties.

### BRIEF DESCRIPTION OF THE DRAWING(S)

FIG. 1 is a schematic cross-sectional view of a rare earth magnet according to an embodiment of the present invention;

FIG. 2 is a schematic cross-sectional view of a magnetic particle according to the embodiment;

FIG. 3 is a diagram showing a manufacturing method of the rare earth magnet according to the embodiment;

FIG. 4 is a schematic diagram of a tumbling fluidized bed apparatus;

FIG. 5A is a graph showing a difference in residual magnetic flux density between the rare earth magnet manufactured from rare earth magnetic powder particles of Example and the rare earth magnet manufactured from rare earth magnetic powder particles of Comparative Example; and

FIG. 5B is a graph showing a difference in coercivity between the rare earth magnet manufactured from the rare earth magnetic powder particles of Example and the rare earth magnet manufactured from the rare earth magnetic powder particles of Comparative Example.

### DETAILED DESCRIPTION OF THE INVENTION

In the following, with reference to the drawings, a rare earth magnet 1 according to an embodiment of the present invention will be described in detail. In the following description, the numerical range “XX to YY” means “XX or more and YY or less” unless otherwise specified.

### Structure of the Rare Earth Magnet 1

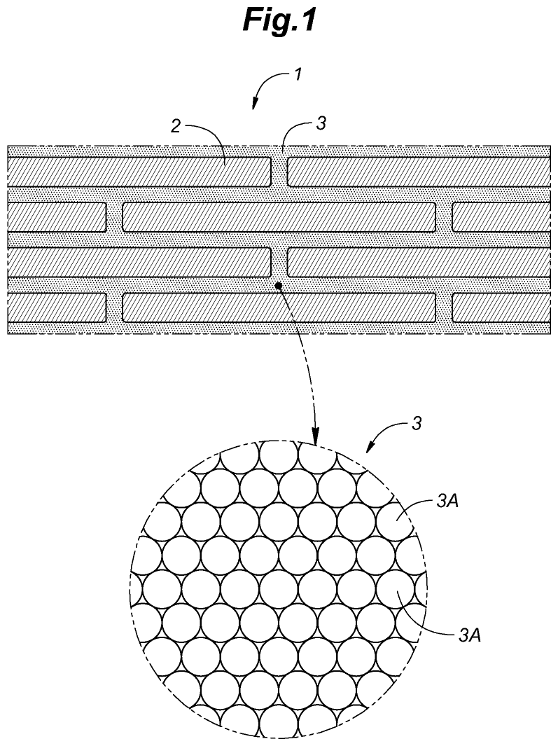

FIG. 1 is a schematic cross-sectional view of the rare earth magnet 1 according to the embodiment. As shown in FIG. 1, the rare earth magnet 1 includes a plurality of rare earth magnetic powder particles 2 arranged so as to be laminated, and an insulating layer 3 having insulating properties and formed on a surface layer of each of the rare earth magnetic powder particles 2. The insulating layer 3 covers at least an outer peripheral surface of the rare earth magnetic powder particles 2.

The rare earth magnetic powder particle 2 is preferably a flake-shaped neodymium magnet (Nd—Fe—B magnet, more precisely Nd₂Fe₁₄B).

The insulating layer 3 includes a plurality of fluoride nanoparticles 3A made of a fluoride. The fluoride nanoparticles 3A may be particles made of calcium fluoride (CaF₂). Calcium fluoride (CaF₂) has a melting point higher than that of the rare earth magnetic powder particles 2, and exhibits low reactivity with the rare earth magnetic powder particles 2. The fluoride nanoparticles 3A preferably have a particle diameter of 1 to 100 nm.

The fluoride nanoparticles 3A may be particles made of an inorganic fluorine compound having insulating properties. The fluoride nanoparticles 3A preferably have a melting point higher than that of the rare earth magnetic powder particle 2 and exhibit low reactivity with the rare earth magnetic powder particles 2. Since the fluoride nanoparticles 3A have a melting point higher than that of the rare earth magnetic powder particle 2 and exhibit low reactivity with the rare earth magnetic powder particle 2, the fluoride nanoparticles 3A are preferably nanoparticles made of calcium fluoride, and may alternatively include nanoparticles made of an alkali metal fluoride such as lithium fluoride, or an alkaline earth metal fluoride such as magnesium fluoride, barium fluoride, or strontium fluoride. The insulating layer 3 may include, as the fluoride nanoparticles 3A, a plurality of nanoparticles made of an alkali metal fluoride and a plurality of nanoparticles made of an alkaline earth metal fluoride. The insulating layer 3 may also include, as the fluoride nanoparticles 3A, nanoparticles containing an alkali metal fluoride and an alkaline earth metal fluoride.

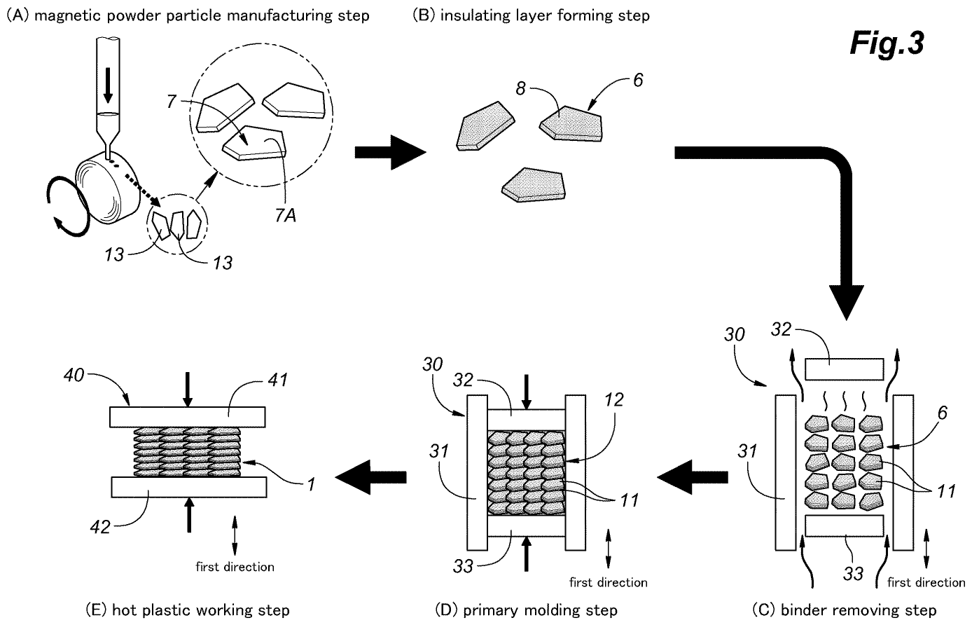

As will be described in detail later, in the manufacturing process of the rare earth magnet 1 (hot plastic working step (E) of FIG. 3), the rare earth magnetic powder particles 2 are heated, while pressure is being applied thereto in a direction (first direction) perpendicular to a main surface thereof. Accordingly, crystal grains in the magnet are shortened in the first direction (compression direction) and elongated in a direction perpendicular to the first direction (direction in which the main surface extends). The rare earth magnet 1 is magnetized in the first direction (compression direction). The crystal grains of the rare earth magnet 1 are oriented as described above, and the rare earth magnet 1 is magnetized as described above, which can increase the squareness ratio of the rare earth magnet 1.

### Structure of the Magnetic Particle 6

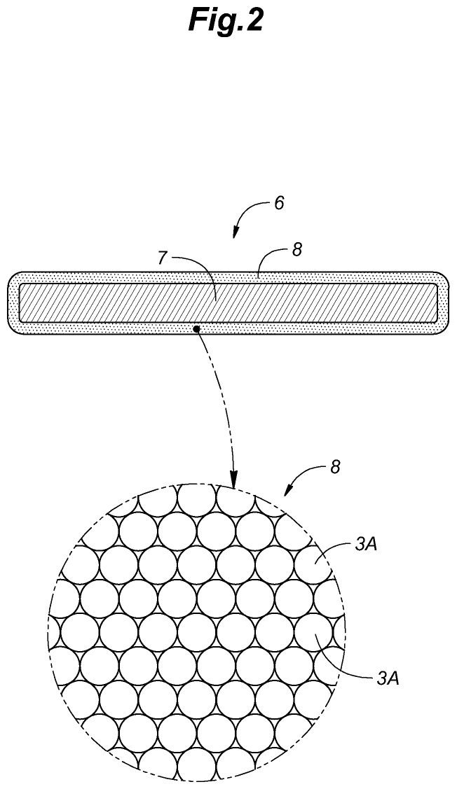

FIG. 2 is a schematic cross-sectional view of the magnetic particle 6 according to the embodiment. The magnetic particle 6 is a material of the rare earth magnet 1. As shown in FIG. 2, the magnetic particle 6 is a powder particle including a rare earth magnetic powder particle 7 and an insulating layer 8 having insulating properties and provided on the surface layer of the rare earth magnetic powder particle 7.

The composition of the rare earth magnetic powder particle 7 is the same as that of the rare earth magnetic powder particle 2. The rare earth magnetic powder particle 7 is a flake-shaped rare earth magnet. The rare earth magnetic powder particle 7 has a particle diameter of 500 μm or more and 600 μm or less. The average thickness of the rare earth magnetic powder particles 7 is 10 μm to 30 μm. The rare earth magnetic powder particle 7 is preferably a flake-shaped neodymium magnet (Nd—Fe—B magnet, more precisely, Nd₂Fe₁₄B). The rare earth magnetic powder particle 7 has anisotropy but may have isotropy. Anisotropy refers to a property in which crystal orientations (easy magnetization axes, c-axes) are aligned in a specific direction. Isotropy refers to a property in which crystal orientations are not aligned in a specific direction.

The insulating layer 8 is provided on the surface layer of the magnetic particle 6 and coats the rare earth magnetic powder particle 7. The insulating layer 8 may include a binder compound and a plurality of fluoride nanoparticles 3A. As described above, the fluoride nanoparticles 3A are particles made of calcium fluoride (CaF₂). The binder compound is an acrylic polymer having a weight average molecular weight greater than 100,000 and not more than 300,000. The acrylic polymer is thermally decomposable at a temperature lower than the melting point of the rare earth magnetic powder particles 7.

The binder compound may be any compound that can bind the fluoride nanoparticles 3A, provided that the binder compound is thermally decomposable at a temperature lower than a melting point of the rare earth magnetic powder particle and does not chemically react with the rare earth magnetic powder particle or the fluoride nanoparticles during thermal decomposition. The binder compound does not necessarily have a weight average molecular weight greater than 100,000 and not more than 300,000. The binder compound is not limited to an acrylic polymer. The binder compound is preferably a resin.

### Manufacturing Method of the Rare Earth Magnet 1

FIG. 3 is a diagram showing the manufacturing method of the rare earth magnet 1. As shown in FIG. 3, the manufacturing method of the rare earth magnet 1 includes a magnetic powder particle manufacturing step (A) of manufacturing the rare earth magnetic powder particles 7, an insulating layer forming step (B) of forming the insulating layer 8 on a surface of each of the rare earth magnetic powder particles 7 to obtain the magnetic particles 6, a binder removing step (C) of removing the binder compound contained in the magnetic particles 6 by thermal decomposition to obtain degreased magnetic powder particles 11, a primary molding step (D) of primary molding the degreased magnetic powder particles 11 using a hot press to obtain a primary molded product 12, and the hot plastic working step (E) of performing hot plastic working on the primary molded product 12 to obtain the rare earth magnet 1.

The magnetic powder particle manufacturing step (A) is a step of manufacturing the flake-shaped rare earth magnetic powder particles 7 having a predetermined size. A melt spinning technique is preferably used in the magnetic powder particle manufacturing step (A). As shown in step (A) of FIG. 3, the melt spinning technique is a technique of obtaining a thin plate-shaped magnet by spraying a rare earth magnet heated to a molten state onto a roll and cooling the sprayed rare earth magnet. The composition of the rare earth magnet to be melted is the same as the composition of the rare earth magnetic powder particle 2. The thin plate-shaped magnet is then pulverized to obtain small magnet pieces 13. Then, the rare earth magnetic powder particles 7 are obtained by classifying the rare earth magnetic powder particles 7 from the small magnet pieces 13. It should be noted that the melt spinning technique does not necessarily have to be used in the magnetic powder particle manufacturing step (A). The magnetic powder particle manufacturing step (A) may be a step of pulverizing a thin plate-shaped rare earth magnet to obtain the rare earth magnetic powder particles 7.

The rare earth magnetic powder particles 7 have a particle diameter of 500 μm or more and 600 μm or less. The average thickness of the rare earth magnetic powder particles 7 is 10 μm to 30 μm. The rare earth magnetic powder particles 7 have anisotropy, but may have isotropy. The oxygen concentration of the rare earth magnetic powder particles 7 can be adjusted such that the rare earth magnet 1 obtained in the hot plastic working step (E) contains 0.12 wt % or less of oxygen.

The rare earth magnetic powder particle 7 has a flake shape and includes a pair of main surfaces 7A. The main surfaces 7A are the largest pair of surfaces among a pair of flat surfaces facing opposite directions. The rare earth magnetic powder particle 7 may have an aspect ratio of approximately 1 (for example, 0.7 to 1.0) when viewed from a direction perpendicular to the main surfaces 7A. The aspect ratio is the ratio of the minor diameter b (minor-axis length) to a major diameter a (major-axis length) of a particle (aspect ratio=minor diameter b/major diameter a). Here, the major diameter a (major-axis length) means a maximum Feret diameter, and the minor diameter b (minor-axis length) means a minimum Feret diameter. The method for measuring the major diameter and the minor diameter complies with the provisions of JIS Z8890:2017 “Particle characterization of particulate systems.”

The insulating layer forming step (B) is a step of forming the insulating layer 8 having insulating properties on the surface layer of each of the rare earth magnetic powder particles 7 to obtain the magnetic particles 6. The magnetic particles 6 are powders obtained by forming the insulating layer 8 on the rare earth magnetic powder particles 7. In the insulating layer forming step (B), using a tumbling fluidized bed apparatus 20, a nanoparticle dispersion liquid containing the plurality of fluoride nanoparticles 3A is sprayed onto the rare earth magnetic powder particles 7 that are being tumbled and fluidized, thereby forming the insulating layer 8 on the surface layer of the rare earth magnetic powder particles 7. As described above, the fluoride nanoparticles 3A according to the present embodiment are made of calcium fluoride (CaF₂) and have a particle diameter of 1 to 100 nm.

The nanoparticle dispersion liquid contains, for example, 4 wt % of the fluoride nanoparticles 3A and 2.5 wt % of the binder compound. Accordingly, the insulating layer 8 formed by drying the nanoparticle dispersion liquid contains 38 wt % of the binder compound and 62 wt % of the fluoride nanoparticles 3A. The fluoride nanoparticles 3A are dispersed in the nanoparticle dispersion liquid. The concentrations of the fluoride nanoparticles 3A and the binder compound in the nanoparticle dispersion liquid, as well as the solvent, may be changed.

The solvent of the nanoparticle dispersion liquid is preferably 2-propanol (also referred to as “isopropyl alcohol” or “IPA”). The solvent of the binder compound solution is not limited to 2-propanol. The solvent of the binder compound solution is preferably alcohol. To allow the solvent to be readily evaporated after the rare earth magnetic powder particles 7 are bound so as to be laminated, the solvent of the binder compound solution is preferably a solvent that readily evaporates at room temperature.

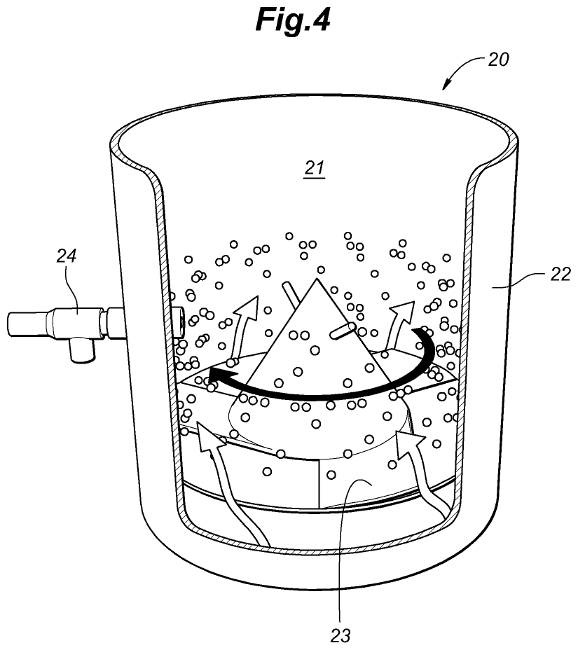

FIG. 4 is a schematic diagram of the tumbling fluidized bed apparatus 20. As shown in FIG. 4, the tumbling fluidized bed apparatus 20 includes a body housing 22 having a fluidized bed 21 therein for tumbling and fluidizing the rare earth magnetic powder particles 7, a rotatable blade rotor 23 that defines the bottom of the fluidized bed 21, a spray nozzle 24 provided on the side of the body housing 22, and an air blower (not shown) that transmits a swirling air flow to the fluidized bed 21 through a gap between the outer circumference of the blade rotor 23 and the body housing 22. The spray nozzle 24 is attached to the body housing 22 to spray the binder compound solution toward the lower portion of the fluidized bed 21.

In the insulating layer forming step (B), as shown in FIG. 4, the rare earth magnetic powder particles 7 are introduced into the fluidized bed 21 of the tumbling fluidized bed apparatus 20. The blade rotor 23 is then rotated, and the air blower generates a swirling air flow within the fluidized bed 21. As a result, the rare earth magnetic powder particles 7 in the fluidized bed 21 are tumbled and fluidized. In this state, the nanoparticle dispersion liquid is sprayed from the spray nozzle 24 onto the rare earth magnetic powder particles 7 that are being tumbled and fluidized. The sprayed nanoparticle dispersion liquid adheres to the surfaces of the rare earth magnetic powder particles 7 and is dried. Accordingly, the insulating layer 8 is formed on the surface layers of the rare earth magnetic powder particles 7, and the magnetic particles 6 are obtained.

The binder removing step (C) is a step of heating the magnetic particles 6 to a temperature equal to or higher than the thermal decomposition temperature of the binder compound to thermally decompose the binder compound, thereby obtaining the degreased magnetic powder particles 11 from which the binder compound has been removed.

In the binder removing step (C), the magnetic particles 6 may be heated within the mold of a hot press machine. As shown in step (C) of FIG. 3, a mold 30 of the hot press machine includes a cylindrical mold body 31, and an upper mold 32 and a lower mold 33 capable of applying a compressive force in a first direction to an object within the mold body 31. In FIG. 3, the first direction is the up-and-down direction, but the first direction may be a direction other than the up-and-down direction.

In the binder removing step (C), the magnetic particles 6 arranged within the mold body 31 of the mold 30 are heated, without pressure being applied by the mold 30 (the upper mold 32 and the lower mold 33), to a temperature equal to or higher than the thermal decomposition temperature of the binder compound (for example, 300 °C to 400 °C) for the predetermined period (for example, 2 to 4 hours) in a reduced pressure environment or in an inert gas flow. The inert gas is a gas having low reactivity with the rare earth magnetic powder particles 7. The inert gas is preferably, for example, a noble gas. The inert gas is preferably helium gas. Air may be used instead of the inert gas when oxidation is not a concern or under controlled conditions.

The products generated by thermal decomposition of the binder compound are discharged to the outside of the mold 30. The binder compound is preferably an acrylic polymer (polymethyl methacrylate) having a weight average molecular weight greater than 100,000 and not more than 300,000. The acrylic polymer is thermally decomposed into the methyl methacrylate monomer. The decomposition products generated by the thermal decomposition of the binder compound volatilize and are discharged to the outside of the mold 30.

When the magnetic particles 6 are heated in the reduced pressure environment in the binder removing step (C), the magnetic particles 6 are heated within the mold body 31 (the mold 30) in the reduced pressure environment. When the magnetic particles 6 are heated in an inert gas flow, the magnetic particles 6 are heated while the inert gas is flowing inside the mold body 31 (the mold 30). This allows the decomposition products of the binder compound (for example, the methyl methacrylate monomer) to readily volatilize and be discharged to the outside of the mold body 31 (the mold 30) when placed in the reduced pressure environment or in the inert gas flow. Further, the decomposition products of the binder compound are less likely to remain around the magnetic particles 6 and less likely to react with the rare earth magnetic powder particles 7, thereby suppressing deterioration of the rare earth magnetic powder particles 7. It is preferable that the inert gas be heated to a temperature equal to or higher than the thermal decomposition temperature of the binder compound before the inert gas is introduced into the mold 30. This allows the binder compound to be heated by the inert gas, thereby promoting the thermal decomposition of the binder compound.

The primary molding step (D) is a step of primary molding, using a hot press, the degreased magnetic powder particles 11 to obtain the primary molded product 12 in which the degreased magnetic powder particles 11 are primarily molded. The mold 30 may be used in the primary molding step (D). The primary molding step (D) is a step of primary molding, using a hot press, the degreased magnetic powder particles 11 obtained by removing the binder compound from the magnetic particles 6 to obtain the primary molded product 12.

The primary molding step (D) may be a step of performing hot forming (primary molding) in which the degreased magnetic powder particles 11 are heated to the predetermined temperature within the mold 30, and the predetermined pressure is applied for the predetermined period. Here, hot forming may be performed at a mold temperature of 600 °C to 700 °C, preferably about 640 °C. When pressure is applied to the degreased magnetic powder particles 11 within the mold 30, the plurality of degreased magnetic powder particles 11 are oriented so that the main surfaces 7A of the rare earth magnetic powder particles 7 contained in the degreased magnetic powder particles 11 face the first direction, and are laminated in a direction (the first direction) perpendicular to the main surfaces 7A. Accordingly, by hot forming, the plurality of degreased magnetic powder particles 11 are compressed and deformed while being laminated in a direction (the first direction) perpendicular to the main surfaces of the degreased magnetic powder particles 11 (the main surfaces 7A of the rare earth magnetic powder particles 7).

The hot plastic working step (E) is a step of performing hot plastic working on the primary molded product 12 obtained in the primary molding step (D) to obtain the rare earth magnet 1. The hot plastic working step (E) includes heating the primary molded product 12, while applying pressure thereto, to a temperature at which a part of the crystal grains of the rare earth magnetic powder particles 7, particularly in a grain boundary region, is softened such that at least a portion of a grain boundary region becomes plastically deformable (melting point of the rare earth magnetic powder particles 7, for example, about 850 °C) thereby plastically deforming the primary molded product 12.

The hot plastic working step (E) is performed using a second mold 40. The second mold 40 has an upper pressing die 41 and a lower pressing die 42 arranged opposite to each other. The primary molded product 12 is arranged within the second mold 40 such that pressure is applied to the plurality of degreased magnetic powder particles 11 contained in the primary molded product 12 in a direction (first direction) perpendicular to the main surfaces. During plastic deformation of the primary molded product 12, the crystal grains of the rare earth magnetic powder particles 7 contained in the primary molded product 12 are oriented such that a c-axis direction (an easy magnetization direction) of the crystal grains is parallel to the first direction (the compression direction). Accordingly, magnetic anisotropy (uniaxial anisotropy) is developed in the primary molded product 12 during the plastic deformation. The rare earth magnetic powder particles 2 contained in the rare earth magnet 1 are obtained by plastically deforming the rare earth magnetic powder particles 7 such that the crystal grains are oriented in the first direction (the compression direction). The rare earth magnet 1 obtained in the hot plastic working step (see FIG. 1) is magnetized in the direction (first direction) in which the magnetic anisotropy is developed.

In the hot plastic working step (E), the degreased magnetic powder particles 11 are heated, while pressure is being applied thereto in a direction (first direction) perpendicular to the main surfaces of the degreased magnetic powder particles 11. Accordingly, the crystal grains in the magnet are shortened in the first direction (the compression direction) and elongated in a direction perpendicular to the first direction (the direction in which the main surface extends). After the hot plastic working step (E), the rare earth magnet 1 is magnetized in the first direction (the compression direction). The crystal grains of the rare earth magnet 1 are oriented as described above, and the rare earth magnet 1 is magnetized as described above, thereby bringing the squareness ratio of the rare earth magnet 1 close to 1.

As shown in FIG. 1, the rare earth magnet 1 is an aggregate of the rare earth magnetic powder particles 2 each having the insulating layer 3 on the surface layer thereof, and has high electrical resistivity due to the insulating layer 3. This reduces the eddy current loss of the rare earth magnet 1. Accordingly, the rare earth magnet 1 has a suitable squareness ratio and reduced eddy current loss.

Next, the effects of the rare earth magnet 1 manufactured in this manner and the manufacturing method thereof will be described.

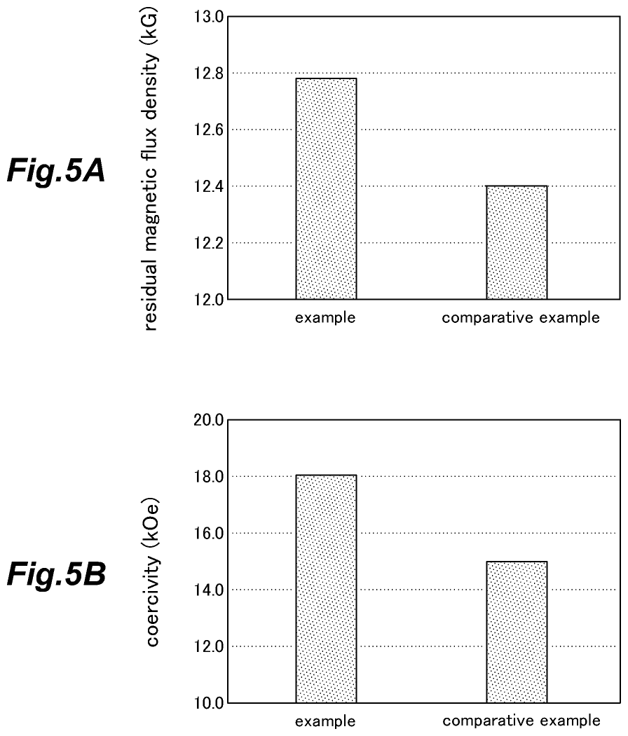

The rare earth magnetic powder particle 7 has a flake shape and a particle diameter of 500 μm or more and 600 μm or less. FIGS. 5A and 5B are graphs showing the differences in residual magnetic flux density and coercivity between the rare earth magnet 1 manufactured from the flake-shaped rare earth magnetic powder particles 7 having a particle diameter of 500 μm or more and 600 μm or less in Example and the rare earth magnet manufactured from the flake-shaped rare earth magnetic powder particles having a particle diameter of 1 μm or more and less than 500 μm in Comparative Example.

The oxygen concentration of the rare earth magnet 1 of Example is 0.11 wt%, and the oxygen concentration of the rare earth magnet of Comparative Example is 0.16 wt%. Accordingly, the oxygen concentration of the rare earth magnet 1 of Example is lower than that of the rare earth magnet of Comparative Example. As shown in FIGS. 5A and 5B, the rare earth magnet 1 of Example has an improved residual magnetic flux density (FIG. 5A) and an improved coercivity (FIG. 5B) compared to the rare earth magnet of Comparative Example. Such improvement is considered to be associated with the fact that the rare earth magnetic powder particles 7 are flake-shaped and have a particle diameter of 500 μm or more and 600 μm or less, which is believed to result in a reduced specific surface area while maintaining suitability for hot plastic working, as compared with general rare earth magnetic powder particles.

Since the rare earth magnetic powder particles 7 have a relatively large particle diameter as compared with generally used rare earth magnetic powder particles, the specific surface area of the rare earth magnetic powder particles 7 is smaller than that of generally used rare earth magnetic powder particles. Accordingly, the rare earth magnetic powder particles 7 are less likely to be oxidized during the process of manufacturing the rare earth magnet 1, and thus the oxygen concentration of the rare earth magnet 1 manufactured from the rare earth magnetic powder particles 7 can be reduced. This can improve the magnetic properties of the rare earth magnet 1 manufactured from the rare earth magnetic powder particles 7. Here, the magnetic properties include, for example, the residual magnetic flux density (see FIG. 5A) and the coercivity (see FIG. 5B). Therefore, it is possible to provide the rare earth magnetic powder particles 7 used as a material for the rare earth magnet 1 having improved magnetic properties.

As shown in FIG. 2, the magnetic particle 6 includes the flake-shaped rare earth magnetic powder particle 7 and the insulating layer 8 having insulating properties and formed on the surface of the rare earth magnetic powder particle 7, and the rare earth magnetic powder particle 7 has a particle diameter of 500μm or more and 600μm or less.

Accordingly, since the rare earth magnetic powder particles 7 contained in the magnetic particles 6 have a large particle diameter as compared with the rare earth magnetic powder particles generally used to manufacture a rare earth magnet, the specific surface area of the rare earth magnetic powder particles 7 is small. Accordingly, the rare earth magnetic powder particles 7 are less likely to be oxidized during the process of manufacturing the rare earth magnet 1, and thus the volume fraction of the insulating layer 8 in the rare earth magnet 1 can be reduced. Since the rare earth magnetic powder particles 7 are less likely to be oxidized and the volume fraction of the insulating layer 8 in the rare earth magnet 1 can be reduced, the magnetic properties (for example, the residual magnetic flux density) of the rare earth magnet 1 are improved. Accordingly, it is possible to provide the magnetic particles 6 used as a material for the rare earth magnet 1 having improved magnetic properties.

The manufacturing method of the rare earth magnet 1 includes the insulating layer forming step (B) of forming the insulating layer 8 on the surface layer of the flake-shaped rare earth magnetic powder particles 7 to obtain the magnetic particles 6, each of the flake-shaped rare earth magnetic powder particles 7 having a particle diameter of 500 μm or more and 600 μm or less, the primary molding step (D) of primary molding, using a hot press, the magnetic particles 6 obtained in the insulating layer forming step (B) to obtain the primary molded product 12, and the hot plastic working step (E) of performing hot plastic working on the primary molded product 12 to obtain the rare earth magnet 1. Accordingly, the rare earth magnet 1 having improved magnetic properties can be manufactured.

In the manufacturing method of the rare earth magnet 1, the oxygen concentration of the rare earth magnetic powder particles 7 is adjusted such that the rare earth magnet 1 obtained in the hot plastic working step (E) contains 0.12 wt % or less of oxygen. This makes the oxygen concentration of the rare earth magnet 1 relatively low, making it possible to manufacture a rare earth magnet 1 having improved magnetic properties.

In the manufacturing method of the rare earth magnet 1, in the insulating layer forming step (B), the insulating layer 8 having a thickness of 200 nm or more and 2 μm or less is formed. Accordingly, since the insulating layer 3 is formed so as to appropriately increase the electrical resistivity of the rare earth magnet 1, it is possible to manufacture a rare earth magnet 1 with reduced eddy current loss.

This concludes the description of the specific embodiment, but the present invention is not limited to the above embodiment and can be widely modified and implemented. For example, the solvent of the binder compound solution and the nanoparticle dispersion liquid is not limited to IPA, and may be an alcohol that is liquid at room temperature, such as 1-propanol or butanol.

The above embodiment may also be described as follows.

One embodiment provides a rare earth magnetic powder particle 7 having a flake shape and a particle diameter of 500 μm or more and 600 μm or less.

According to this aspect, since the rare earth magnetic powder particles 7 have a large particle diameter as compared with the rare earth magnetic powder particles generally used to manufacture a rare earth magnet, the specific surface area of the rare earth magnetic powder particles 7 is small. Accordingly, the rare earth magnetic powder particles 7 are less likely to be oxidized during the process of manufacturing the rare earth magnet 1, thereby contributing to improvement of the magnetic properties of the rare earth magnet 1 manufactured from the rare earth magnetic powder particles 7. Therefore, it is possible to provide the rare earth magnetic powder particles 7 used as a material for the rare earth magnet 1 having improved magnetic properties.

Another embodiment provides a magnetic particle 6 used as a material for a rare earth magnet 1, comprising: a flake-shaped rare earth magnetic powder particle 7; and an insulating layer 8 having insulating properties and formed on a surface of the rare earth magnetic powder particle 7. The rare earth magnetic powder particle 7 has a particle diameter of 500 μm or more and 600 μm or less.

According to this aspect, since the rare earth magnetic powder particles 7 have a large particle diameter as compared with the rare earth magnetic powder particles generally used to manufacture a rare earth magnet, the specific surface area of the rare earth magnetic powder particles 7 is small. Accordingly, the rare earth magnetic powder particles 7 are less likely to be oxidized during the process of manufacturing the rare earth magnet 1, and thus the volume fraction of the insulating layer 8 in the rare earth magnet 1 can be reduced. Since the rare earth magnetic powder particles 7 are less likely to be oxidized and the volume fraction of the insulating layer 8 in the rare earth magnet 1 is reduced, the magnetic properties of the rare earth magnet 1 can be improved. Accordingly, it is possible to provide the magnetic particles 6 used as a material for the rare earth magnet 1 having improved magnetic properties.

Another embodiment provides a manufacturing method of a rare earth magnet 1, comprising: an insulating layer forming step (B) of forming an insulating layer 8 having insulating properties on a surface layer of a plurality of flake-shaped rare earth magnetic powder particles 7 to obtain a plurality of magnetic particles 6, each of the plurality of flake-shaped rare earth magnetic powder particles having a particle diameter of 500 μm or more and 600 μm or less; a primary molding step (D) of primary molding, using a hot press, the plurality of magnetic particles 6 obtained in the insulating layer forming step (B) to obtain a primary molded product 12 in which the plurality of magnetic particles 6 is primarily molded; and a hot plastic working step (E) of performing hot plastic working on the primary molded product 12 obtained in the primary molding step (D) to obtain the rare earth magnet 1.

According to this aspect, it is possible to manufacture the rare earth magnet 1 having improved magnetic properties.

In one embodiment, in the manufacturing method of the rare earth magnet 1, an oxygen concentration of the plurality of rare earth magnetic powder particles 7 is adjusted such that the rare earth magnet 1 obtained in the hot plastic working step (E) contains 0.12 wt % or less of oxygen.

According to this aspect, since the rare earth magnet 1 with a relatively low oxygen concentration can be manufactured, it is possible to manufacture the rare earth magnet 1 having improved magnetic properties.

In one embodiment, in the manufacturing method of the rare earth magnet 1, the insulating layer 8 having a thickness of 200 nm or more and 2 μm or less is formed in the insulating layer forming step (B).

According to this aspect, since the insulating layer 8 is formed so as to appropriately increase the electrical resistivity of the rare earth magnet 1, it is possible to manufacture the rare earth magnet 1 with reduced eddy current loss.

1. A rare earth magnetic powder particle used as a material for a rare earth magnet, wherein the rare earth magnetic powder particle has a flake shape and a maximum Feret diameter, measured parallel to a main surface thereof, of 500 μm or more and 600 μm or less.

2. A magnetic particle used as a material for a rare earth magnet, comprising:
a flake-shaped rare earth magnetic powder particle; and
an insulating layer having insulating properties and formed on a surface of the rare earth magnetic powder particle, wherein the rare earth magnetic powder particle has a particle diameter defined as a maximum Feret diameter measured parallel to a main surface thereof of 500 μm or more and 600 μm or less.

3. A manufacturing method of a rare earth magnet, comprising:
an insulating layer forming step of forming an insulating layer having insulating properties on a surface layer of a plurality of flake-shaped rare earth magnetic powder particles to obtain a plurality of magnetic particles, each of the flake-shaped rare earth magnetic powder particles having a particle diameter defined as a maximum Feret diameter measured parallel to a main surface thereof of 500 μm or more and 600 μm or less;
a primary molding step of primary molding, using a hot press, the plurality of magnetic particles obtained in the insulating layer forming step to obtain a primary molded product in which the plurality of magnetic particles is primarily molded; and
a hot plastic working step of performing hot plastic working on the primary molded product obtained in the primary molding step to obtain the rare earth magnet.

4. The manufacturing method of the rare earth magnet according to claim 3, wherein an oxygen concentration of the plurality of rare earth magnetic powder particles is adjusted such that the rare earth magnet obtained in the hot plastic working step contains 0.12 wt % or less of oxygen.

5. The manufacturing method of the rare earth magnet according to claim 3, wherein the insulating layer having a thickness of 200 nm or more and 2 μm or less is formed in the insulating layer forming step.
